(19) United States
(12) Patent Application Publication
(10) Pub. No.: US 2024/0337760 A1
(43) Pub. Date: Oct. 10, 2024

(54) METHOD AND APPARATUS FOR ESTIMATING CARRIER PHASE OFFSET IN SATELLITE NAVIGATION SYSTEM

(71) Applicant: Electronics and Telecommunications Research Institute, Daejeon (KR)

(72) Inventor: Kwang Jae LIM, Daejeon (KR)

(73) Assignee: Electronics and Telecommunications Research Institute, Daejeon (KR)

(21) Appl. No.: 18/467,506

(22) Filed: Sep. 14, 2023

(30) Foreign Application Priority Data
Apr. 10, 2023 (KR) 10-2023-0047008

(51) Int. Cl. G01S 19/43; G01S 19/40

(52) U.S. Cl. CPC G01S 19/43; G01S 19/40

(57) ABSTRACT

A method of a terminal may comprise: receiving satellite navigation augmentation information including phase offset correction information for a pair of two carriers among satellite navigation signals transmitted by each of satellites of a global navigation satellite system through multiple carriers; receiving satellite navigation signals from each of the satellites through the multiple carriers; calculating parameters for estimating a location of the terminal using the received satellite navigation signals; correcting the parameters based on the phase offset correction information for the pair of two carriers; and estimating the location of the terminal using the corrected parameters.

### CROSS-REFERENCE TO RELATED APPLICATIONS

This application claims priority to Korean Patent Application No. 10-2023-0047008, filed on Apr. 10, 2023, with the Korean Intellectual Property Office (KIPO), the entire contents of which are hereby incorporated by reference.

### BACKGROUND

### 1. Technical Field

Exemplary embodiments of the present disclosure relate to a technique for carrier offset estimation in a wireless communication system, and more specifically, to a technique for estimating a phase offset of a carrier in a satellite navigation system.

### 2. Related Art

In a satellite navigation system (e.g., Global Navigation Satellite System, GNSS), a receiver estimates its location by receiving satellite navigation signals transmitted from a plurality of satellites. Various accuracy augmentation methods for the GNSS receiver, such as Differential GNSS (DGNSS) and Precise Point Positioning (PPP), have been proposed and utilized to achieve positioning accuracy at the level of several centimeters to several tens of centimeters. Within the context of augmenting positioning accuracy, key factors include the utilization of augmentation information and the estimation of carrier phase offsets of the navigation signals. Here, the augmentation information may refer to satellite navigation augmentation information.

### SUMMARY

Exemplary embodiments of the present disclosure are directed to providing a method and an apparatus for augmenting accuracy of carrier phase offsets in a satellite navigation system.

According to a first exemplary embodiment of the present disclosure, a method of a terminal may comprise: receiving satellite navigation augmentation information including phase offset correction information for a pair of two carriers among satellite navigation signals transmitted by each of satellites of a global navigation satellite system (GNSS) through multiple carriers; receiving satellite navigation signals from each of the satellites through the multiple carriers; calculating parameters for estimating a location of the terminal using the received satellite navigation signals; correcting the parameters based on the phase offset correction information for the pair of two carriers; and estimating the location of the terminal using the corrected parameters.

The satellite navigation augmentation information may be information transmitted by a station generating the satellite navigation augmentation information through at least one of the satellites, information transmitted by the station through the Internet, a mobile communication network, or a separate network, or information directly transmitted by the station.

The phase offset correction information for the pair of two carriers may be information on a phase difference between the two carriers constituting the pair.

The parameters may be corrected using weights between the multiple carriers when correcting the parameters.

The weights between the multiple carriers may be received as being included in the satellite navigation augmentation information.

The weights between the multiple carriers may be determined based on information of received signal strengths of the respective multiple carriers.

The method may further comprise updating previously stored satellite navigation augmentation information when the satellite navigation augmentation information is received.

According to a second exemplary embodiment of the present disclosure, a terminal may comprise a processor, and the processor may cause the terminal to perform: receiving satellite navigation augmentation information including phase offset correction information for a pair of two carriers among satellite navigation signals transmitted by each of satellites of a global navigation satellite system (GNSS) through multiple carriers; receiving satellite navigation signals from each of the satellites through the multiple carriers; calculating parameters for estimating a location of the terminal using the received satellite navigation signals; correcting the parameters based on the phase offset correction information for the pair of two carriers; and estimating the location of the terminal using the corrected parameters.

The satellite navigation augmentation information may be information transmitted by a station generating the satellite navigation augmentation information through at least one of the satellites, information transmitted by the station through the Internet, a mobile communication network, or a separate network, or information directly transmitted by the station.

The phase offset correction information for the pair of two carriers may be information on a phase difference between the two carriers constituting the pair.

The processor may further cause the terminal to correct the parameters using weights between the multiple carriers when correcting the parameters.

The weights between the multiple carriers may be received as being included in the satellite navigation augmentation information.

The weights between the multiple carriers may be determined based on information of received signal strengths of the respective multiple carriers.

The processor may further cause the terminal to update previously stored satellite navigation augmentation information when the satellite navigation augmentation information is received.

According to a third exemplary embodiment of the present disclosure, a method of a station in a global navigation satellite system (GNSS) may comprise: receiving satellite navigation signals through multiple carriers from each of satellites of the GNSS; calculating phase offset correction information for a pair of two carriers among the satellite navigation signals received through the multiple carriers; generating satellite navigation augmentation information including the calculated phase offset correction information; and broadcasting the satellite navigation augmentation information based on a transmission period of the satellite navigation augmentation information.

The satellite navigation augmentation information may be broadcasted through at least one of the satellites, broadcasted through the Internet, a mobile communication network, or a separate network, or broadcasted directly by the station.

The phase offset correction information for the pair of two carriers may be information on a phase difference between the two carriers constituting the pair.

According to exemplary embodiments of the present disclosure, a station (e.g., augmentation station) of a satellite navigation system may generate and broadcast satellite navigation augmentation information, which includes phase differences among satellite navigation signals transmitted through multiple carriers. As a result, a terminal can receive the satellite navigation augmentation information from the station or a satellite, including the phase differences, and utilize it to correct the satellite navigation signals, allowing for a more accurate estimation of the terminal's location.

### BRIEF DESCRIPTION OF DRAWINGS

FIG. 1 is a conceptual diagram illustrating an exemplary embodiment of a satellite navigation system according to the present disclosure.

FIG. 2 is a block diagram of an augmentation station according to an exemplary embodiment of the present disclosure in a satellite navigation system.

FIG. 3 is a flowchart of a method for an augmentation station to broadcast satellite navigation augmentation information according to an exemplary embodiment of the present disclosure.

FIG. 4 is a block diagram of a terminal according to the present disclosure.

FIG. 5 is a flowchart for a method of determining a location of a terminal according to an exemplary embodiment of the present disclosure.

FIG. 6 is a conceptual timing diagram illustrating broadcasting of phase differences of different carriers by the augmentation station according to the present disclosure.

### DETAILED DESCRIPTION OF THE EMBODIMENTS

Exemplary embodiments of the present disclosure are disclosed herein. However, specific structural and functional details disclosed herein are merely representative for purposes of describing exemplary embodiments of the present disclosure. Thus, exemplary embodiments of the present disclosure may be embodied in many alternate forms and should not be construed as limited to exemplary embodiments of the present disclosure set forth herein.

Accordingly, while the present disclosure is capable of various modifications and alternative forms, specific exemplary embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular exemplary embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may have the same meaning as a communication network.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

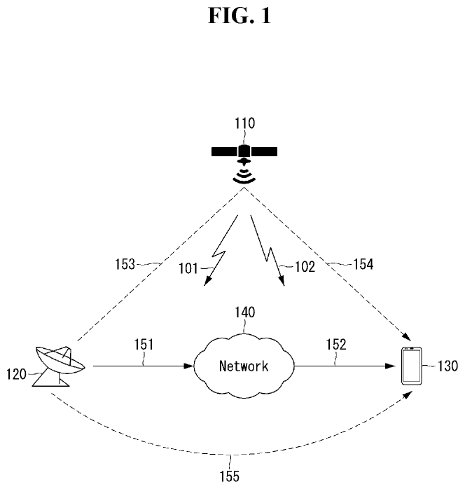

FIG. 1 is a conceptual diagram illustrating an exemplary embodiment of a satellite navigation system according to the present disclosure.

Referring to FIG. 1, a satellite navigation system (e.g., GNSS) may include a satellite 110 and an augmentation service station 120 and a terminal 130 located on the ground. In FIG. 1, only one satellite 110 is illustrated for convenience of description, but the satellite navigation system may include a plurality of satellites. Accordingly, it should be noted that FIG. 1 is an example for describing a case in which one satellite transmits one or more carriers. In addition, the augmentation service station 120 may be a configuration for broadcasting augmentation information according to the present disclosure, and may be referred to as an ‘augmentation station’. In the following description, it will be described as a ‘station’ or ‘augmentation station’ for convenience of description.

The satellite 110 may transmit satellite navigation signals 101 and 102 using multiple carriers. In FIG. 1, the satellite navigation signals 101 and 102 may be transmitted through different carriers. For example, the first satellite navigation signal 101 may be a satellite navigation signal transmitted (or broadcasted) to a configured area through a first carrier having a first frequency f1, and the second satellite navigation signal 102 may be a satellite navigation signal transmitted (or broadcasted) to the same terrestrial area as the area for the first satellite navigation signal or an area at least partially overlapping the area for the first satellite navigation signal through a second carrier having a second frequency f2.

In the example of FIG. 1, only two carriers are illustrated as f1 and f2 due to drawing limitations, but the satellite 110 may transmit satellite navigation signals through three or more carriers. In addition, each of the satellite navigation signals 101 and 102 may be transmitted after being spread by a spreading code for identifying the satellite. Accordingly, satellite navigation signals transmitted by each of a plurality of satellites may be identified by different spreading codes.

The augmentation station 120 may be installed at a specific location on the ground. As another example, when the augmentation station 120 is installed in a moving object, for example, a vehicle, it may stay in one location for a long time. The augmentation station 120 may generate satellite navigation augmentation information according to the present disclosure. In the following description, for convenience of description, it is assumed that the augmentation station 120 is a terrestrial station installed in a specific location on the ground.

The augmentation station 120 may receive the satellite navigation signals 101 and 102 from the satellite 110 through multiple carriers. The augmentation station 120 may generate satellite navigation augmentation information according to the present disclosure by using the satellite navigation signals 101 and 102 received at a predetermined time period. It is assumed that the augmentation station 120 knows its exact location. In addition, since the augmentation station 120 is located in a specific fixed location or is located in a specific location for a long time, it can receive signals more reliably than the moving terminal 130. Accordingly, when compared with the terminal 130, the augmentation station 120 may generate more accurate augmentation information. For example, when the terminal 130 moves at a high speed or at a low speed, a Doppler effect may be generated based on the movement speed of the terminal 130. In addition, when vibration occurs due to movement of the terminal 130, phase noises due to a shock may occur in an oscillator inside the terminal 130. On the other hand, since the augmentation station 120 is located in a specific location, it may be free from such the phenomenon. Accordingly, satellite navigation augmentation information generated by the augmentation station 120 may be generally more accurate than information obtained by the terminal 130 for position estimation (i.e., positioning).

The augmentation station 120 may transmit (or broadcast) the generated satellite navigation augmentation information to the terminal 130 at a predetermined time period. For example, the augmentation station 120 may transmit (or broadcast) the generated satellite navigation augmentation information to the terminal 130 through a predetermined network 140 and/or the satellite 110. For example, the satellite navigation augmentation information generated by the augmentation station 120 may be provided to the terminal 130 through the network 140 as shown by reference numerals 151 and 152. As another example, the satellite navigation augmentation information generated by the augmentation station 120 may be provided to the terminal 130 through the satellite 110 as shown by reference numerals 153 and 154. As yet another example, the satellite navigation augmentation information generated by the augmentation station 120 may be directly transmitted from the augmentation station 120 to the terminal 130 as shown by reference numeral 155.

The network 140 illustrated in FIG. 1 may be a network of various types. For example, the network 140 may be a wireless Internet such as wireless fidelity (WiFi), portable Internet such as wireless broadband internet (WiBro) or world interoperability for microwave access (WiMax), 2G mobile network such as global system for mobile communication (GSM) or code division multiple access (CDMA), 3G mobile network such as wideband code division multiple access (WCDMA) or CDMA2000, 3.5G mobile network such as high speed downlink packet access (HSDPA) or high speed uplink packet access (HSUPA), 4G mobile communication network such as a long term evolution (LTE) network or an LTE-Advanced network, and 5G mobile communication network. As another example, the network 140 may be at least one of various networks such as a wired IP network using the Internet protocol and/or terrestrial Internet.

The terminal 130 may be any type of terminal capable of determining the location of the terminal 130 by receiving the satellite navigation signals 101 and 102 and satellite navigation augmentation information according to the present disclosure. The terminal 130 according to the present disclosure may receive the satellite navigation augmentation information directly from the augmentation station 120, through the network 140, or through the satellite 110. In the present disclosure, the method for the augmentation station 120 to transmit such satellite navigation augmentation information is not particularly limited.

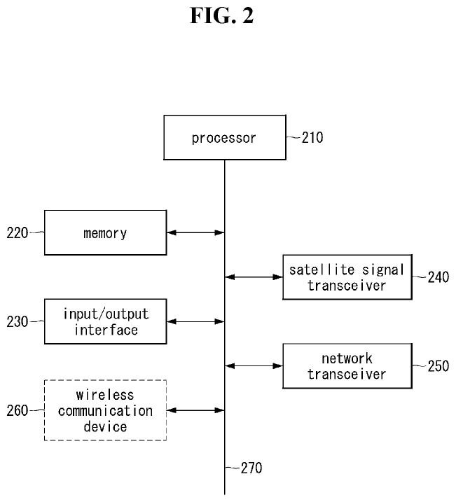

FIG. 2 is a block diagram of an augmentation station according to an exemplary embodiment of the present disclosure in a satellite navigation system.

Referring to FIG. 2, the augmentation station may include a processor 210, memory 220, input/output interface 230, satellite signal transceiver 240, network transceiver 250, and wireless communication device 260. In addition, the respective components 210, 220, 230, 240, 250, and 260 of the augmentation station may perform communications as being connected by a bus 270. However, the components 210 to 270 of the augmentation station illustrated in FIG. 2 are shown merely as an exemplary embodiment. In other words, the augmentation station may further include additional components in addition to the components illustrated in FIG. 2. For example, the augmentation station may further include various devices such as a separate storage device, sensor(s), and separate output device.

The processor 210 may have one or more cores. As another example, the processor 210 may be implemented as a complex processor including two or more processors. Specifically, the processor may be configured to include at least one of an application processor (AP) operating as a central processing unit (CPU), communication processor (CP) performing transmission/reception of satellite signals, or graphics processing unit (GPU) for providing an operating state of the augmentation station to a user or operator.

The processor 210 may execute program commands stored in the memory 220. For example, the processor 210 may execute program commands stored in the memory 220 to control operations of the augmentation station, output of the operating state of the augmentation station to a user or operator, and generation and transmission of satellite navigation augmentation information according to the present disclosure. In other words, the processor 210 may perform control of generation of satellite navigation augmentation information and transmission of the generated satellite navigation augmentation information according to the present disclosure, as well as various controls to be performed by the augmentation station 120.

The memory 220 may include at least one of volatile storage media and non-volatile storage media. The memory 220 may include at least one of read only memory (ROM), random access memory (RAM), or hard disk. The memory 220 may store the program commands to be executed by the processor 210 and may temporarily store data generated when the program commands are executed by the processor 210. Also, the memory 220 may have a region for storing satellite navigation augmentation information according to the present disclosure.

The input/output interface 230 may include an input interface and an output interface. The input interface may be connected to various types of input devices, and may receive various commands or information input by a user or operator of the augmentation station and provide the received information to the processor 210. In addition, the output interface may be connected to various types of output devices, and may provide a user or operator of the augmentation station 120 with state information of the augmentation station, visual and/or audio information for input, and the like.

The satellite signal transceiver 240 may include antenna(s) capable of receiving satellite navigation signals transmitted by a plurality of satellites through multiple carriers. In addition, the satellite signal transceiver 240 may have a configuration for converting multiple carriers of a radio frequency (RF) band, which are received through the antenna(s), into a digital intermediate frequency (IF) band or converting signals in the digital IF band into baseband signals. The satellite signal transceiver 240 may include a configuration for generating satellite navigation augmentation information according to the present disclosure using the baseband signals or provide the baseband signals to the processor 210 through the bus 270. The satellite signal transceiver 240 may include a configuration for converting baseband signals to be transmitted to a satellite into digital IF band signals and RF band signals.

In addition, since the augmentation station 120 stays at a specific location for a long time when it is fixedly installed at a specific place on the ground or located on a moving object, the satellite signal transceiver 240 can reliably receive satellite navigation signals from a plurality of satellites through multiple carriers.

The network transceiver 250 may include a configuration for transmitting data to the network 140 described in FIG. 1. For example, when the network 140 is a mobile communication network, the network transceiver 250 may provide an interface for communication with the mobile communication network in a wired or wireless communication scheme. When the network 140 is an IP-based Internet network, the network transceiver 250 may provide an interface for Internet communication.

### [Generation and Broadcasting of Satellite Navigation Augmentation Information]

Hereinafter, methods of generating satellite navigation augmentation information and methods of broadcasting the generated satellite navigation augmentation information according to the present disclosure will be described with reference to FIGS. 1 and 2.

Since the following description is based on the configuration of the satellite navigation system of FIG. 1, a case in which multiple carriers broadcasted by one satellite are received will be described. However, even when each of a plurality of satellites transmits multiple carriers, the augmentation station 120 may generate satellite navigation augmentation information according to the present disclosure in the same manner as the method of receiving multiple carriers broadcasted by one satellite.

Referring to FIG. 1, the satellite 110 may generate the satellite navigation signals 101 and 102. Then, the satellite 110 may spread the satellite navigation signals 101 and 102 using a specific spreading code assigned to the satellite, and then broadcast them through multiple carriers. Each of the augmentation station 120 and the terminal 130 located on the ground may receive the satellite navigation signals 101 and 102 broadcasted by the satellite 110.

The satellite signal transceiver 240 of the augmentation station 120 may receive the satellite navigation signals 101 and 102 through antenna(s), and convert the received RF band signals into IF band signals of the IF band. In addition, the satellite signal transceiver 240 may convert the IF band signals into digital IF band signals or baseband signals. Since the satellite signal transceiver 240 receives multiple carriers, it is possible to obtain digital IF band or baseband signals for each carrier. The satellite signal transceiver 240 may provide the obtained digital IF band or baseband signals to the processor 210. Each of the satellite navigation signals converted into digital signals may be expressed as in Equation 1 below.

$$r ( t ) = Ad ( t - {t}^{′} ) c ( t - {t}^{′} ) {e}^{j ( 2 π {f}^{′} + ϕ )} + n ( t ) \qquad [ Equation 1 ]$$

In Equation 1, A denotes the size of the received satellite navigation signal, d (t) denotes a modulated signal of satellite navigation data, c (t) denotes a spreading code signal for satellite identification, and n (t) denotes a noise signal. In addition, t′ denotes a reception time offset, f′ denotes a frequency offset, and @ denotes a phase offset. In order to estimate the location of the receiver, that is, the augmentation station 120, the three offsets (i.e., reception time offset, frequency offset, and phase offset) need to be accurately estimated.

In the present disclosure, a method for accurately estimating the phase offset among the three offsets will be described. Therefore, the satellite navigation augmentation information according to the present disclosure described hereinafter may include at least information on the phase offset.

Since only the phase offset is considered in the present disclosure, a signal transmitted through a carrier i excluding the modulated signal, spreading code, time offset, and frequency offset in Equation 1 may be briefly expressed as in Equation 2 below.

$${r}_{i} ( t ) = {e}^{j {ϕ}_{i}} + n ( t ) \qquad [ Equation 2 ]$$

As described above, the satellite 110 may broadcast the satellite navigation signals using multiple carriers. Accordingly, the processor 210 of the augmentation station 120 may measure (or estimate) and obtain phase offsets of a plurality of carrier signals, that is, the multiple carriers. In addition, when a plurality of satellites broadcast satellite navigation signals using multiple carriers, the processor 210 of the augmentation station 120 may measure (or estimate) a phase offset of each of a plurality of carriers received from each of the plurality of satellites.

As described above with reference to FIGS. 1 and 2, the augmentation station 120 may generally know its location. In detail, information on the location may be stored in the memory 220 of the augmentation station 120. Therefore, the processor 210 of the augmentation station 120 may measure and obtain the phase offsets of the multiple carriers based on the location of the augmentation station 120, which is read from the memory 220, and/or other various information. In this case, as described above, since the augmentation station 120 can perform reliable estimation for a long time in a stationary state, it can generally obtain the phase offsets of the multiple carriers more accurately than the terminal 130.

The processor 210 of the augmentation station 120 may calculate a difference between the phase offsets of several carriers (e.g., carrier i and carrier j) as shown in Equation 3 below.

$${Δϕ}_{j , i} ( t ) = {ϕ}_{j} ( t ) - {ϕ}_{j} ( t ) \qquad [ Equation 3 ]$$

The phase offsets in Equation 3 may be generated by combinations of pairs of two carriers based on the number of the multiple carriers. For example, when there are three carriers, the number of cases in which two carriers are selected from the three carriers may be three. As another example, when satellite navigation signals are transmitted through five carriers, the number of cases in which two carrier are selected from the five carriers may be ten.

Accordingly, the processor 210 may generate as many phase offsets as the number of cases in which carrier pairs each composed of two carriers can be selected based on the number of multiple carriers. The generated phase offsets may be included in the satellite navigation augmentation information as the phase offset correction information. In this case, the phase offset correction information may further include information on the pairs of the carriers. For example, assuming three carriers, a first carrier f1, a second carrier f2, and a third carrier 3, the phase offset correction information may include information on three phase offsets and information on three pairs.
(1) Information on the first carrier, the second carrier, and Δϕ_{f}_{₁}_{,f}_{₂}(tₙ)
(2) Information on the second carrier, the third carrier, and Δϕ_{f}_{₂}_{,f}_{₃}(tₙ)
(3) Information on the third carrier, the first carrier, and Δϕ_{f}_{₃}_{,f}_{₁}(tₙ)

The processor 210 of the augmentation station 120 may generate satellite navigation augmentation information including at least information on the phase offsets, and broadcast it at predetermined time intervals. The broadcasting of the satellite navigation augmentation information may be performed through the network 140 or the satellite 110, or the satellite navigation augmentation information may be directly broadcasted by the augmentation station 120. In addition, the broadcasting of the satellite navigation augmentation information may be performed using all of the above-described methods or a combination of two or more among the above-described methods.

In this case, when the satellite navigation augmentation information is broadcasted through the satellite 110, the processor 210 may control the satellite signal transceiver 240 to transmit, to the satellite 110, the navigation satellite augmentation information and satellite broadcast control information for configuring the satellite 110 to transmit the satellite navigation augmentation information through all carriers for transmission of the satellite navigation signals. Here, the satellite broadcast configuration information may be information indicating the satellite 110 to broadcast specific information (e.g., satellite navigation augmentation information). When receiving the satellite broadcast configuration information configured such that satellite navigation augmentation information is transmitted through all satellite navigation signals, the satellite 110 may transmit the satellite navigation augmentation information through all carriers for transmission of the satellite navigation signals.

As another example, the processor 210 may configure the satellite broadcast configuration information such that the satellite navigation augmentation information is to be transmitted only through a specific representative carrier. In addition, the processor 210 may transmit, to the satellite 110, the satellite broadcast configuration information and the satellite navigation augmentation information. The satellite 110 receiving the satellite broadcast configuration information and the satellite navigation augmentation information may transmit the satellite navigation augmentation information only through the representative carrier configured by the augmentation station 120.

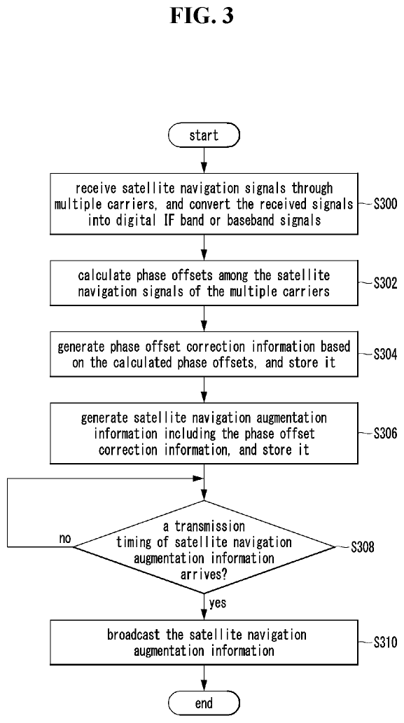

FIG. 3 is a flowchart of a method for an augmentation station to broadcast satellite navigation augmentation information according to an exemplary embodiment of the present disclosure.

FIG. 3 illustrates operations of the augmentation station 120 according to the present disclosure, and the operations of the augmentation station 120 will be described with reference to the components of FIG. 2.

In a step S300, the processor 210 of the augmentation station 120 may control the satellite signal transceiver 240 to receive the satellite navigation signals 101 and 102 from satellites through multiple carriers. In addition, the processor 210 may control the satellite signal transceiver 240 to convert the received signals into digital signals. In other words, the processor 210 may control the satellite signal transceiver 240 to convert received RF band signals into digital IF band signals or digital baseband signals.

In a step S302, the processor 210 of the augmentation station 120 may calculate phase offsets between the satellite navigation signals. The calculation may be performed as shown in Equation 3 described above. When there are three or more satellite navigation signals, three or more phase offsets may be calculated. As described above, the processor 210 may generate as many phase offsets as the number of cases in which carrier pairs each composed of two carriers can be selected based on the number of multiple carriers.

Since the augmentation station 120 is located in a specific location for a long time in a stationary state, the exact location of the augmentation station 120 may be known. In addition, since the augmentation station 120 stays in one location for a long time in a stationary state, the augmentation station 120 can receive multiple carriers more reliably. As such, the augmentation station 120 may reliably receive the multiple carriers and more accurately estimate the phase offsets thereof.

In a step S304, the processor 210 of the augmentation station 120 may generate phase offset correction information based on the calculated phase offsets. In this case, the generated phase offset correction information may include only the phase offsets or may further include information on carriers corresponding to the phase offsets. In addition, the processor 210 may store the generated phase offset correction information in the memory 220.

In a step S306, the processor 210 of the augmentation station 120 may generate satellite navigation augmentation information including the phase offset correction information. The processor 210 may store the satellite navigation augmentation information generated in the above-described manner in the memory 220.

In a step S308, the processor 210 of the augmentation station 120 may identify whether a transmission timing of the satellite navigation augmentation information arrives. The satellite navigation augmentation information may be broadcasted at preset time intervals, that is, at a predetermined time period. For example, a transmission period of the satellite navigation augmentation information may be assumed to be set in units of preset periods such as 10 seconds, 1 minute, or 5 minutes. In this case, the processor 210 may drive a timer corresponding to the predetermined period at a previous transmission timing to identify whether a transmission timing of the satellite navigation augmentation information arrives.

The processor 210 may proceed to a step S310 when the transmission timing of satellite navigation augmentation information arrives, and may stand by when the transmission timing of satellite navigation augmentation information does not arrive.

In the step S310, the processor 210 of the augmentation station 120 may broadcast the satellite navigation augmentation information generated in the step S306 and stored in the memory 220. For example, the processor 210 may control the satellite signal transceiver 240 to transmit the satellite navigation augmentation information through satellites. As another example, the processor 210 may control the network transceiver 250 to transmit the satellite navigation augmentation information through the network 140. As yet another example, the processor 210 may control the wireless communication device 260 to directly transmit the satellite navigation augmentation information to terminals. As yet another example, the processor 210 may control at least two or more of the satellite navigation augmentation information transmission methods described above to be performed together.

A time required for the terminal 130 to initially estimate a more accurate location may be determined based on the transmission timing, that is, the transmission periodicity, of the satellite navigation augmentation information described above. Accordingly, the transmission period of the satellite navigation augmentation information may be determined based on loads of the satellite 110 and/or the network 140 and an allowable time for initial accurate position estimation of the terminal 130.

In the method described above, the case in which satellite navigation augmentation information is transmitted at a specific period has been described. However, when the satellite 110 is used to transmit the satellite navigation augmentation information, the augmentation station 120 may control the satellite 110 to transmit the satellite navigation augmentation information together with the satellite navigation signals. In this case, information on a timing at which the satellite navigation augmentation information is updated may be transmitted. Through this, the satellite navigation augmentation information may be transmitted based on information on a timing at which the satellite navigation augmentation information is provided to the satellite 110 or the timing at which the satellite navigation augmentation information is updated.

### [Phase Offset Correction Using Satellite Navigation Augmentation Information]

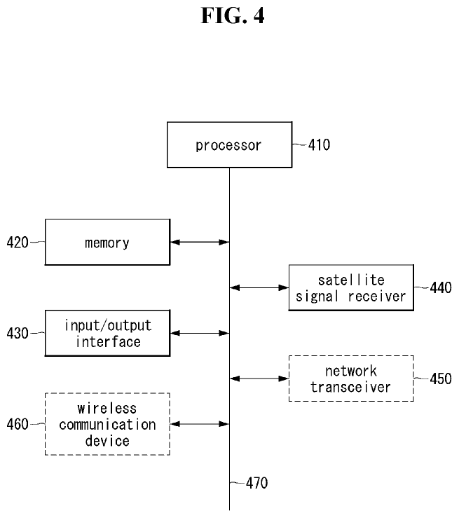

FIG. 4 is a block diagram of a terminal according to the present disclosure.

The terminal illustrated in FIG. 4 may be one of various types of devices for performing navigation by receiving the satellite navigation signals. For example, the terminal may be in various forms, such as a receiving terminal exclusively for navigation, a notebook computer, a vehicle terminal, a smart phone, smart glasses, a smart watch, a ship or an aircraft, or an unmanned aerial vehicle (UAV). Therefore, it should be noted that components of the terminal disclosed in FIG. 4 exemplify only components required to describe the features of the present disclosure. In other words, additional components may be further included in addition to the components illustrated in FIG. 4.

The terminal may include a processor 410, a memory 420, an input/output interface 430, a satellite signal transceiver 440, and a network transceiver 450. In addition, the respective components 410, 420, 430, 440, and 450 of the terminal may perform communications with each other as being connected by a bus 470.

The processor 410 may have one or more cores. As another example, the processor 410 may be implemented as a complex processor including two or more processors. Specifically, the processor may be configured to include at least one of an AP operating as a CPU, communication processor (CP) performing transmission/reception of satellite signals, or GPU for providing an operating state of the terminal to a user or operator.

The processor 410 may execute program commands stored in the memory 420. For example, the processor 410 may execute program commands stored in the memory 420 to control operations of the terminal. For example, the processor 410 may control reception of satellite navigation signals, and measure (or estimate) a time offset, a frequency offset, and a phase offset from the received satellite navigation signal. In addition, the processor 410 may receive the satellite navigation augmentation information to obtain the phase offset correction information according to the present disclosure. The processor 410 may correct the phase offset of the satellite navigation signal based on the obtained phase offset correction information. In addition, the processor 410 may determine the location of the terminal through phase offset correction. In addition, the processor 410 may perform overall control for navigation of the terminal.

The memory 420 may include at least one of volatile storage media and non-volatile storage media. The memory 420 may include at least one of ROM, RAM, or hard disk. The memory 420 may store the program commands to be executed by the processor 410 and may temporarily store data generated when the program commands are executed by the processor 410. Also, the memory 220 may have a region for storing satellite navigation augmentation information according to the present disclosure.

The input/output interface 430 may include an input interface and an output interface. The input interface may be connected to various types of input devices, and may receive various commands or information input by a user or operator of the augmentation station and provide the received information to the processor 410. In addition, the output interface may be connected to various types of output devices, and may provide a user or operator of the terminal with state information of the terminal, visual and/or audio information for input, and the like.

The satellite signal receiver 440 may have a configuration of converting RF band signals of antenna(s) for receiving the satellite navigation signals through multiple carriers, which are transmitted by a plurality of satellites, into digital IF band signals of the IF band, or converting them into digital baseband signals. In addition, the satellite signal receiver 440 may provide the satellite navigation signal converted into the digital IF band signals or digital baseband signals of the IF band to the processor 410. When the satellite transmits the satellite navigation augmentation information, the satellite signal receiver 440 may convert the satellite navigation augmentation information into a digital IF band signal or a digital baseband signal of the IF band and further provide the converted signal to the processor 410.

When necessary, the satellite signal receiver 440 may further include a transmitter for transmitting signals to the satellite. In the present disclosure, since an operation of transmitting signals to the satellite by the terminal is not required, a configuration for transmitting signals to the satellite will not be further described.

The network transceiver 450 may include a configuration for communicating with the network 140 described in FIG. 1. For example, when the network 140 is a mobile communication network, the network transceiver 450 may transmit and receive signals based on a mobile communication scheme corresponding to the mobile communication network. When the network 140 is an IP-based Internet network, the network transceiver 450 may provide an interface for Internet communication. The network transceiver 450 may be a component required when the augmentation station 120 according to the present disclosure transmits satellite navigation augmentation information through the network 140. Accordingly, it should be noted that the network transceiver 450 is indicated by a dotted line in FIG. 4.

The wireless communication device 460 may be configured to receive the satellite navigation augmentation information when the augmentation station 120 directly transmits the satellite navigation augmentation information based on a predetermined wireless communication scheme. The wireless communication device 460 may be a configuration required only when only the augmentation station 120 transmits the satellite navigation augmentation information. If, for example, the augmentation station 120 directly transmits the satellite navigation augmentation information and simultaneously transmits it through the satellite and/or network, the wireless communication device 460 may become an unnecessary configuration.

Hereinafter, a procedure for the terminal to obtain satellite navigation information based on satellite navigation augmentation information will be described with reference to FIGS. 1 and 4.

The satellite signal receiver 440 of the terminal 130 may receive the satellite navigation signals 101 and 102 through antenna(s), and convert the received RF band signals into digital IF band signals of the digital IF band or digital baseband signals. The satellite navigation signals converted into the digital IF band signals or digital baseband signals may be expressed as in Equation 1 described above. The satellite signal receiver 440 may provide the received satellite navigation signals to the processor 410.

In addition, the satellite signal receiver 440 or the network transceiver 450 of the terminal may receive the satellite navigation augmentation information transmitted from the augmentation station 120 according to the present disclosure. The satellite navigation augmentation information may include phase offset correction information as described above. The satellite signal receiver 440 or the network transceiver 450 may provide the obtained phase offset correction information or satellite navigation augmentation information including the phase offset correction information to the processor 410.

The processor 410 may use the satellite navigation augmentation information transmitted by the augmentation station 120 in estimating the satellite navigation signals. In particular, the processor 410 according to the present disclosure may use the phase offset correction information included in the satellite navigation augmentation information in estimating phase offsets of multiple carrier signals received from satellites.

The processor 410 may estimate the phase offsets of the respective carrier signals, and calculate the location of the terminal using the estimated phase offsets. A detailed method of calculating the location of the terminal by the processor 410 is beyond the scope of the present disclosure, and thus will not be described in detail herein.

Then, the correction of the phase offset will be described.

The processor 410 may estimate a phase offset ϕᵢ′(tₙ+τ) of a carrier i through which the satellite navigation signal is transmitted. The phase offset may be obtained by measuring a correlation between the carrier signal received at the terminal 130 from the satellite 110 and a carrier signal known to the terminal in advance. More specifically, the terminal may generate in advance the carrier i for transmitting the satellite navigation signal. Then, the terminal may measure a phase difference between the carrier i received from the satellite and the carrier i generated by itself. The processor 410 may obtain the measured phase difference, that is, the phase offset ϕᵢ′(tₙ+τ).

The processor 410 may calculate a corrected phase offset as shown in Equation 4 below using the difference between the phase offset obtained through measurement and the offset of the carrier frequency obtained through the satellite navigation augmentation information.

$${ϕ}_{i}^{″} ( {t}_{n} + τ ) = {ϕ}_{i}^{′} ( {t}_{n} + τ ) + {\sum }_{j = 1}^{N} {ω}_{j , i} ( {Δϕ}_{j , i}^{′} ( {t}_{n} + τ ) - {Δϕ}_{j , i} ( {t}_{n} + τ ) ) / {\sum }_{j = 1}^{N} {ω}_{j , i} \qquad [ Equation 4 ]$$

In Equation 4, ϕ′ᵢ(tₙ+τ) denotes the phase offset estimated by the terminal for the satellite navigation signal i, Δϕ′_{j,i}(tₙ) denotes the phase offset difference most recently broadcast by the augmentation station 120, and ω_{j,i} denotes a weight for the carrier j through which the satellite navigation signal is transmitted relative to the carrier I through which the satellite navigation signal to be estimated. When the weight ω_{j,i} of the carrier j through which the satellite navigation signal is transmitted relative to the carrier i through which the satellite navigation signal to be estimated is transmitted is 1, the same weight may be applied to all signals.

Information on weights for the respective carriers through the satellite navigation signals are transmitted may be determined by the terminal itself, or may be transmitted as being included in augmentation information broadcasted by the satellite 110 or the augmentation station 120. When the terminal determines the weights by itself, the determination may be made based on a received signal strength of the satellite navigation signal i and a received signal strength of the satellite navigation signal j.

As described above, the processor 410 of the terminal 130 may additionally correct the phase offset obtained from the signal received from the satellite by using the phase offset correction information in the satellite navigation augmentation information broadcasted by the augmentation station 120, so that a more accurate correction on the phase offset can be performed. In other words, the satellite 110 may transmit the satellite navigation signals through multiple carriers, and the augmentation station 120 receiving the satellite navigation signals may broadcast the phase offset difference between each pair of the carriers to terminals by including it in the satellite navigation augmentation information. Then, the processor 410 of the terminal 130 receiving the satellite navigation signals and the satellite navigation augmentation information may more accurately estimate the location of the terminal 130 by additionally correcting the estimated satellite offset using the phase offset difference for each frequency. In other words, the processor 410 may more accurately calculate the location of the terminal by correcting the phase offset of the received satellite navigation signal.

A method of estimating the location of the receiver using phase offsets of a plurality of navigation signals received from a plurality of satellites may be performed in several known schemes, and a detailed description thereof will be omitted since it is out of the scope of the present disclosure.

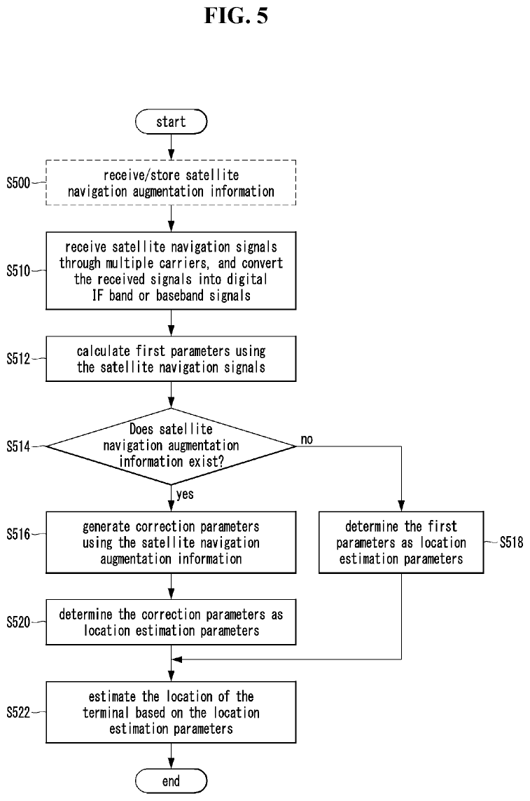

FIG. 5 is a flowchart for a method of determining a location of a terminal according to an exemplary embodiment of the present disclosure.

FIG. 5 illustrates operations of the terminal 130 according to the present disclosure, and the operations of the terminal 130 will be described with reference to the components of FIG. 4.

In a step S500, the processor 410 of the terminal 130 may receive satellite navigation augmentation information and store it in the memory 420. As described above, the satellite navigation augmentation information may be broadcast by the augmentation station 120 at a preconfigured periodicity. The satellite navigation augmentation information may be broadcasted through the satellite 110 or the network 140 or directly by the augmentation station 120, or two or more among the satellite, network, or augmentation station may broadcast the satellite navigation augmentation information together. Accordingly, the processor 410 may control one of the satellite receiver 440, the network transceiver 450, or the wireless communication device 460 to receive the satellite navigation augmentation information based on the scheme in which the satellite navigation augmentation information is transmitted. When the satellite navigation augmentation information is transmitted from all of the satellite 110, the network 140, and the augmentation station 120, the processor 410 may receive the satellite navigation augmentation information using only the satellite receiver 440. This is because it is a method of saving power of the terminal 130, and also because there is no need to receive the same information through multiple devices.

In addition, the processor 410 may be in a state in which the satellite navigation augmentation information is not received. The case when the satellite navigation augmentation information is not received may be a case when the power of the terminal 130 is immediately turned on from a power off state, or a case when the user requests to perform a navigation (or determination of the location of the terminal 130) in a state in which execution of a navigation (or location determination) is not requested.

When the power of the terminal 130 is turned on from the power off state, the terminal 130 may not have performed the step S500 because the terminal 130 has not received the satellite navigation augmentation information periodically broadcasted by the augmentation station 120. In addition, if the user does not request navigation (or location determination) from the terminal 130, the processor 410 may not receive satellite navigation augmentation information because it does not need to receive the satellite navigation information. Therefore, in this case, the step S500 may not be performed. As another example, when the satellite navigation augmentation information is transmitted using the network 400 and the terminal 130 cannot communicate with the corresponding network 400, the step S500 may not be performed. In FIG. 5, the step S500 is indicated by a dotted line to confirm that it may or may not be performed in advance.

When receiving the satellite navigation augmentation information, the processor 410 may update satellite navigation augmentation information previously stored in the memory 420 with the newly received satellite navigation information. As another example, the processor 410 may accumulate and store the satellite navigation augmentation information by a predetermined number. Also, the processor 410 may determine that the satellite navigation augmentation information is not valid in certain cases. For example, if a timing at which the satellite navigation augmentation information is received is older than a preconfigured time from the current time, the processor 410 may determine that it is unreliable. The processor 410 may delete the satellite navigation augmentation information when it is determined that it is unreliable. The step S500 may be preceded by at least one of the operations described above.

A step S510 may be performed when the user instructs the terminal 130 to perform a navigation (location determination). Also, the step S510 may be continuously performed when the navigation is running. Accordingly, in the step S510, the processor 410 may control the satellite signal receiver 440 to receive satellite navigation signals transmitted from the satellite 110 through multiple carriers. In this case, when the satellite 110 transmits the satellite navigation augmentation information together, in the step S510, the satellite signal receiver 440 may convert the satellite navigation signals and the satellite navigation augmentation information together into digital IF band signals or digital baseband signals of the IF band, and provide them to the processor 410. That is, the processor 410 may receive baseband satellite navigation signals from the satellite signal receiver 440. In addition, when the satellite 110 broadcasts the satellite navigation signals and the satellite navigation augmentation information together, the processor 410 may also receive the satellite navigation augmentation information.

In a step S512, the processor 410 may calculate first parameters using the digital IF band signals or the digital baseband signals of the IF band received from the satellite signal receiver 440. The first parameters described in the present disclosure may be parameters for estimating the location of the terminal, and may include a time offset, frequency offset, and phase offset of each of multiple carriers. In other words, the first parameters may be parameters for accurate estimation of multiple carriers through which the satellite navigation signals are transmitted. Since the present disclosure proposes a method for correcting the phase offset, the time offset and frequency offset will not be further described. Among the first parameters, the phase offset may be calculated as described in FIG. 4.

When the satellite signal receiver 440 receives both the satellite navigation augmentation information and the satellite navigation signals according to the present disclosure, in the step S512, the processor 410 may extract the satellite navigation augmentation information from the digital baseband signals and may store in the memory 420 in the step S512.

In a step S514, the processor 410 may identify whether satellite navigation augmentation information pre-stored in the memory 420 exists or whether satellite navigation augmentation information has been received from the satellite signal receiver 440. As a result of the identification in the step S514, if satellite navigation augmentation information is previously stored in the memory 420 or if satellite navigation augmentation information is received together with the satellite navigation signals, the processor 410 may proceed to a step S516. On the other hand, as a result of the identification in the step S514, if satellite navigation augmentation information is not previously stored in the memory 420 and satellite navigation augmentation information is not received along with the satellite navigation signals, the processor 410 may proceed to s step S518.

The step S518 may correspond to a case where there is no satellite navigation augmentation information. Accordingly, in the step S518, the processor 410 may determine the first parameters calculated in the step S512 as location estimation parameters. The step S518 may correspond to a general positioning operation to which satellite navigation augmentation information according to the present disclosure is not applied. Therefore, it may correspond to a case of using the first parameters as the location determination parameters as they are in order to estimate (or determine) the location of the terminal. After determining the location estimation parameters as described above, the processor 410 may proceed to a step S522.

The step S518 may be an initial procedure in which power is initially turned on for the terminal 130 or navigation is requested by the user. Thereafter, when the satellite navigation augmentation information transmitted by the augmentation station 120 is received, the step S518 may not be performed. Accordingly, how long the step S518 is performed may be determined based on a scheme and period in which the augmentation station 120 transmits the satellite navigation augmentation information.

For example, when the augmentation station 120 is configured to broadcast the satellite navigation augmentation information together with the satellite navigation signals through the satellite 110, the step S518 may be performed once or may be performed without the step S518.

As another example, when the augmentation station 120 is configured to broadcast the satellite navigation augmentation information together with satellite navigation signals through the specific network 140 without using the satellite 110, based on a broadcasting period of the network 140, the number of performing the step S518 may be determined.

As yet another example, when the augmentation station 120 directly broadcasts the satellite navigation augmentation information at a specific periodicity, the number of performing the step S518 may be determined based on the transmission period of the satellite navigation augmentation information by the augmentation station 120.

The step S516 may a case where the satellite navigation augmentation information transmitted by the augmentation station 120 is received. Accordingly, the processor 410 may generate correction parameters using the satellite navigation augmentation information. The satellite navigation augmentation information according to the present disclosure may include phase offset correction information. Based thereon, the processor 410 may correct the phase offset among the first parameters. The correction of the phase offset may be performed as in Equation 4 described above. In more detail, the correction of the phase offset according to the present disclosure may be performed using weights. Since these weights have already been described above, the redundant description will be omitted.

In the step S520, the processor 410 may determine the correction parameters generated in the step S518 as location estimation parameters. In the step S522, the processor 410 may estimate (or determine) the location of the terminal using the location estimation parameters. The step S522 may use the location estimation parameters determined in the step S518 or step S520. Therefore, the step S522 may be applied both when the phase offset is corrected based on the satellite navigation augmentation information according to the present disclosure or when the satellite navigation augmentation information is not received.

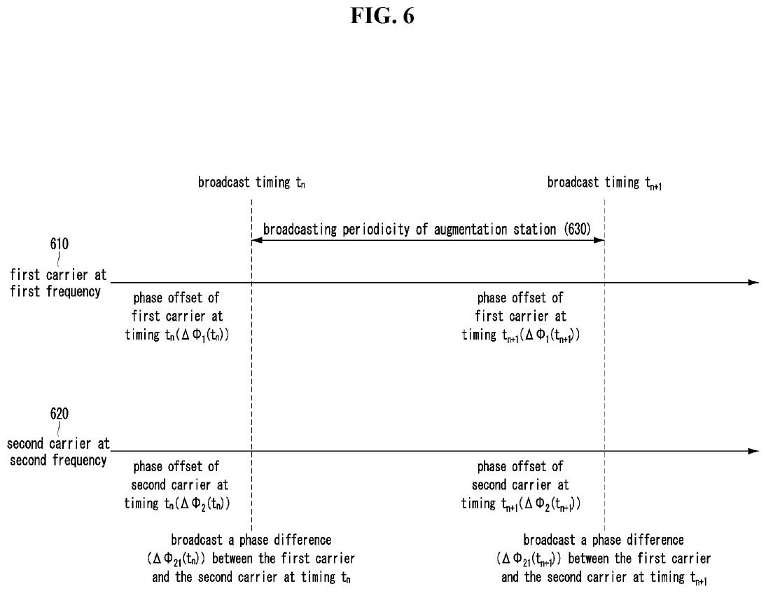

FIG. 6 is a conceptual timing diagram illustrating broadcasting of phase differences of different carriers by the augmentation station according to the present disclosure.

The satellites of the GNSS may transmit satellite navigation signals using multiple carriers of different frequencies. FIG. 6 illustrates a case in which a GNSS satellite transmits a first carrier 610 of a first frequency and a second carrier 620 of a second frequency. A phase offset at a timing tₙ of the first carrier 610 of the first frequency may be expressed as Δϕ₁(tₙ). In addition, a phase offset at the timing tₙ of the second carrier 620 of the second frequency may be expressed as Δϕ₁(tₙ).

The augmentation station 120 may calculate a difference value Δϕ₂₁(tₙ) between the phase offset Δϕ₁(tₙ) for the first carrier 610 and the phase offset Δϕ2(tₙ) for the second carrier 620 before the broadcast timing tₙ, and broadcast the difference value of the phase offset at the timing tₙ.

As described above, such broadcasting may be performed based on a preset period, for example, a broadcasting period 630 of the augmentation station. Accordingly, the augmentation station 120 may calculate the phase difference value of the next timing before a next broadcasting period arrives. For example, a difference Δϕ₂₁(tₙ₊₁) between a phase offset Δϕ₁(tₙ₊₁) at a timing tₙ₊₁ for the first carrier 610 of the first frequency and a phase offset Δϕ₂(tₙ₊₁) at the timing tₙ₊₁ for the second carrier 620 of the second frequency may be calculated. It may be preferable to perform the calculation immediately prior to the broadcast timing based on computational capability of the augmentation station 120.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
receiving satellite navigation augmentation information including phase offset correction information for a pair of two carriers among satellite navigation signals transmitted by each of satellites of a global navigation satellite system (GNSS) through multiple carriers;
receiving satellite navigation signals from each of the satellites through the multiple carriers;
calculating parameters for estimating a location of the terminal using the received satellite navigation signals;
correcting the parameters based on the phase offset correction information for the pair of two carriers; and
estimating the location of the terminal using the corrected parameters.

2. The method according to claim 1, wherein the satellite navigation augmentation information is information transmitted by a station generating the satellite navigation augmentation information through at least one of the satellites, information transmitted by the station through the Internet, a mobile communication network, or a separate network, or information directly transmitted by the station.

3. The method according to claim 1, wherein the phase offset correction information for the pair of two carriers is information on a phase difference between the two carriers constituting the pair.

4. The method according to claim 3, wherein the parameters are corrected using weights between the multiple carriers when correcting the parameters.

5. The method according to claim 4, wherein the weights between the multiple carriers are received as being included in the satellite navigation augmentation information.

6. The method according to claim 5, wherein the weights between the multiple carriers are determined based on information of received signal strengths of the respective multiple carriers.

7. The method according to claim 1, further comprising updating previously stored satellite navigation augmentation information when the satellite navigation augmentation information is received.

8. A terminal comprising a processor, wherein the processor causes the terminal to perform:
receiving satellite navigation augmentation information including phase offset correction information for a pair of two carriers among satellite navigation signals transmitted by each of satellites of a global navigation satellite system (GNSS) through multiple carriers;
receiving satellite navigation signals from each of the satellites through the multiple carriers;
calculating parameters for estimating a location of the terminal using the received satellite navigation signals;
correcting the parameters based on the phase offset correction information for the pair of two carriers; and
estimating the location of the terminal using the corrected parameters.

9. The terminal according to claim 8, wherein the satellite navigation augmentation information is information transmitted by a station generating the satellite navigation augmentation information through at least one of the satellites, information transmitted by the station through the Internet, a mobile communication network, or a separate network, or information directly transmitted by the station.

10. The terminal according to claim 8, wherein the phase offset correction information for the pair of two carriers is information on a phase difference between the two carriers constituting the pair.

11. The terminal according to claim 10, wherein the processor further causes the terminal to correct the parameters using weights between the multiple carriers when correcting the parameters.

12. The terminal according to claim 11, wherein the weights between the multiple carriers are received as being included in the satellite navigation augmentation information.

13. The terminal according to claim 12, wherein the weights between the multiple carriers are determined based on information of received signal strengths of the respective multiple carriers.

14. The terminal according to claim 8, wherein the processor further causes the terminal to update previously stored satellite navigation augmentation information when the satellite navigation augmentation information is received.

15. A method of a station in a global navigation satellite system (GNSS), comprising:
receiving satellite navigation signals through multiple carriers from each of satellites of the GNSS;
calculating phase offset correction information for a pair of two carriers among the satellite navigation signals received through the multiple carriers;
generating satellite navigation augmentation information including the calculated phase offset correction information; and
broadcasting the satellite navigation augmentation information based on a transmission period of the satellite navigation augmentation information.

16. The method according to claim 15, wherein the satellite navigation augmentation information is broadcasted through at least one of the satellites, broadcasted through the Internet, a mobile communication network, or a separate network, or broadcasted directly by the station.

17. The method according to claim 15, wherein the phase offset correction information for the pair of two carriers is information on a phase difference between the two carriers constituting the pair.
